(19) United States
(12) Patent Application Publication
(10) Pub. No.: US 2008/0245273 A1
(43) Pub. Date: Oct. 9, 2008

(54) Hydrophobic coatings

(76) Inventors: Jouko Vyorkka, Richterswil (CH); Gerald A. Vandezande, Raleigh, NC (US); Pekka J. Salminen, Galgenen (CH); Bruno Ruh, Luzern (CH); Andrew Fogden, Cook (AU); Robert Corkery, Stockholm (SE)

Correspondence Address: The Dow Chemical Company, Intellectual Property Section, P.O. Box 1967, Midland, MI, 48641-1967, US

(21) Appl. No.: 11/784,069

(22) Filed: Apr. 5, 2007

(51) Int. Cl. C04B 16/00

(52) U.S. Cl. 106/665

(57) ABSTRACT

A process for improving the hydrophobicity of architectural coating compositions and adhesive release surface compositions, the process comprising preparing at least one of said compositions using the following components: inorganic particles, at least one fatty acid or a salt thereof, a polymeric binder, and water. There is further disclosed a method for preparing an aqueous composition and a method of coating a substrate.

### BACKGROUND OF THE INVENTION

The present invention relates to hydrophobic, highly hydrophobic and superhydrophobic materials.

Hydrophobicity as such, as well as other parameters related to this, are important end-performance requirements for various water-based coatings and materials. Various architectural coatings, such as paints as well as elastomeric and deck coatings may be used to increase surface hydrophobicity in order to protect the substrate from the negative effect of water contact. Such hydrophobicity increase may also result in a self-cleaning surface that improves the dirt pick-up resistance of the surface.

Caulks and sealants are used in various applications to provide resistance to water intrusion into a substrate material. High hydrophobicity is thus a desirable property for caulks and sealants.

The key performance criteria of an adhesive release surface, such as the nonadhesive side of an adhesive tape, is to provide low adhesion to the adhesive surface that it is pressed against.

In the art many approaches have been used to manufacture hydrophobic materials.

WO 2005/100459 A1 relates to a coating material comprising a binding agent, at least one filler containing particles having a size and/or surface roughness of 10 μm or less, and a photocatalytically active agent. The binding agent is at least partially decomposed by photocatalytic action, and a microstructured, self-cleaning surface is formed. However, this material requires a photocatalytic pigment and a solvent.

US 2006/0141223 A1 relates to textile sheet-like constructions having enhanced watertight properties and to a process for producing them. This patent however requires solvent and relates to fiber modification in textile applications

WO 2001/062863 A1 relates to an aqueous laquer dispersion suitable for hydrophobic coatings. The material is mainly carboxylated polystyrene pigments, wherein part of the carboxylic groups are esterified with fluorinated aliphatic alcohols.

US 2006/0257643 A1 describes a method of producing hydrophobic composites and aggregates. The process requires several process steps and is not suited to preparing continuous coatings.

The published French patent application FR 2 852 966 discloses an aqueous composition for treating surfaces and making them hydrophobic, comprising a thermoplastic polymer in an aqueous emulsion and mineral particles having a size from 5 to 500 μm. The mineral can be for instance calcium carbonate, quartz, mica, talc, titanium dioxide, barium sulphate, calcium sulphate etc. The polymer can be for instance polystyrene, polymethacrylate, polyvinyl butyral, and polyurethane.

U.S. Pat. No. 6,712,932 discloses a paper or a paper-like material with a structure, comprising particles of, for instance, metal oxides and carbonates, which are fixed to the paper by means of a wet-laying method using a binder together with a water-repelling agent.

U.S. Pat. No. 6,660,363 discloses a self-cleaning surface comprising elevations made of hydrophobic polymers or permanently hydrophobized materials.

US 2005/0136217 A1 discloses a self-cleaning object with a layer of hydrophobic material having protrusions and recesses, which layer is applied with a solution, dispersion or emulsion containing hydrophobic material and a liquid where the liquid is evaporated. The mixture may also comprise other solid particles.

Highly hydrophobic wet-laid coatings may be divided into two main types of coating treatments, either solvent-borne or water-borne. Solvent-borne treatments are subject to controls or regulatory limitations in some countries. On the other hand, water-borne coating treatments are usually more difficult to implement in order to obtain hydrophobic coatings and thus more limited than solvent-borne coating treatments, due to the dual requirement for a stable coating dispersion in the aqueous phase and for hydrophobicity in the dry state of the final coating layer. In particular, the application of the superhydrophobic coating often involves multiple steps by creating surface structure and low surface energy coating in different steps. Moreover, standard oil-in-water emulsion-based strategies for encapsulating and delivering hydrophobic species tend to leave an emulsifier (e.g. surfactant) on the coated surface upon drying, which in turn tends to enhance wetting.

Other disadvantages of prior art methods are that coatings may be made of expensive materials and cannot easily be applied using existing processes and equipment. Other problems in the prior art related to highly hydrophobic coatings include the use of silane treated and/or fluorinated components, which are expensive. Another problem in the prior art is that hydrophobic coatings require multiple steps for the application, which often leads to use of more material and a more complicated process for the application. Thus there is a need for an alternative coating composition that would be effective in rendering surfaces hydrophobic without having the above-mentioned drawbacks.

### SUMMARY OF THE INVENTION

The present invention relates to the use of an aqueous dispersion in the manufacture of a hydrophobic coating, caulk, sealant or adhesive release surface composition, said aqueous dispersion comprising inorganic particles, at least one fatty acid or a salt thereof, a polymeric binder, and water.

The invention includes a process comprising preparing an architectural coating composition that provides a hydrophobic coating when applied to a substrate, the composition being in the form of an aqueous dispersion, the composition comprising:
a) inorganic particles
b) at least one fatty acid or a salt thereof,
c) a polymeric binder, and
d) water.

In another embodiment, the invention is process comprising preparing an adhesive release surface coating composition that provides a hydrophobic adhesive release surface coating when applied to a substrate, the composition being in the form of an aqueous dispersion, the composition comprising:
a) inorganic particles
b) at least one fatty acid or a salt thereof,
c) a polymeric binder, and
d) water.

The invention further contemplates a process for improving the hydrophobicity of coatings prepared from an architectural coating composition or adhesive release surface coating composition, the process comprising preparing the composition such that it is in the form of an aqueous dispersion and comprises:
a) inorganic particles
b) at least one fatty acid or a salt thereof,
c) a polymeric binder, and
d) water.

Further embodiments of the present invention are defined in the appended dependent claims, which are specifically incorporated by reference herein.

This invention can be employed without using solvents, fluorochemicals, silanes, nanoparticles or nanofibers, and does not require chemical vapor deposition. The invention is not based on physical rupturing of a hydrophobic surface. Advantageously, the invention uses materials that are environmentally friendly, inexpensive and available in large quantities. The one pot preparation process creates desirable surface structure and hydrophobicity simultaneously. In addition, the properties of the formulation (rheology, solids content, etc.) are suitable for application with conventional application techniques.

### DETAILED DESCRIPTION OF THE INVENTION

Before the invention is disclosed and described in detail, it is to be understood that this invention is not limited to particular configurations, process steps and materials disclosed herein as such configurations, process steps and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents unless the context clearly dictates otherwise.

The term “about” as used in connection with a value throughout the description and the claims means that the true value can be up to 10% higher or down to 10% lower than the indicated value.

If nothing else is defined, any terms and scientific terminology used herein are intended to have the meanings commonly understood by those of skill in the art to which this invention pertains.

The following terms are used throughout the description and the claims.

“Acicular” is used herein to denote a needle-like shape.

“Antioxidant” as used herein denotes a substance capable of preventing, slowing down, or suppressing oxidation.

“Apparent density” as used herein denotes dry mass per unit volume of a material including voids inherent in the material.

“Aqueous dispersion” as used herein encompasses a mixture comprising water.

“Architectural coating” as used herein includes coatings such as exterior or interior house paints, deck coatings, elastomeric coatings, polymeric coatings for exterior insulating finishing systems, mastics, caulks, sealants and industrial maintenance coatings.

“Basic” as used herein denotes a material or compound that has a functional group with the ability to take up a proton.

“Biocide” as used herein denotes a substance capable of preventing, slowing down, or suppressing growth of living organisms.

“Coalescence agent” as used herein denotes an agent that causes or promotes coalescence.

For the purposes of the present invention, the term “copolymer” means a polymer formed from at least 2 monomers.

“Crosslinks” as used herein denotes any bonds linking one polymer chain to another.

“D₅₀” as used herein denotes the 50^{th} percentile of the mass-weighted size distribution of particles. Accordingly 50% of the inorganic particles have a size greater than D₅₀ and 50% of the inorganic particles have a size of less than D₅₀. The particle size is determined for the primary particles if the particles are not aggregated in larger agglomerates, but if the particles are aggregated in larger agglomerates the size of the agglomerates is measured.

“Defoaming agents” as used herein denotes a substance capable of preventing, slowing down, or suppressing foaming.

“Dry weight” as used herein denotes the weight of materials other than water, i.e “dry” means substantially in the absence of water.

“Inorganic particle” as used herein denotes a particle comprising inorganic material, although small amounts of organic material may be present.

“Fungicide” as used herein denotes a substance capable of preventing, slowing down, or suppressing growth of fungi.

“Highly hydrophobic” is used herein to denote a surface with an equilibrium contact angle between 120 degrees and 150 degrees for a drop of water on the surface.

“Hydrophobic” as used herein denotes the property to repel water. A hydrophobic surface is a surface with a contact angle of more than 90 degrees but less than 120 degrees.

“Inorganic particle” as used herein encompasses an inorganic particle of any shape.

“Low Tg monomer” as used herein denotes a monomer for which a homopolymer prepared therefrom has a glass transition temperature of less than or equal to 10° C.

For the purposes of the present invention, the term “(meth)” indicates that the methyl substituted compound is included in the class of compounds modified by that term. For example, the term (meth)acrylic acid represents acrylic acid and methacrylic acid.

“Optical brighteners” as used herein denotes dyes that absorb light in the ultraviolet and violet region of the electromagnetic spectrum and re-emit light in the blue region.

“Polymeric binder” as used herein denotes a binder that is a polymer.

“Rheology modifiers” as used herein denotes a substance with the capability to modify Theological properties of a fluid.

“Scalenohedral” as used herein denotes a pyramidal form under the rhombohedral system, enclosed by twelve faces, each a scalene triangle.

“Substance” as used herein denotes a pure or a non-pure chemical compound or a mixture of chemical compounds; thus, for example, a mineral is encompassed within the term.

“Superhydrophobic” as used herein denotes a surface with an equilibrium contact angle higher than 150 degrees for a drop of water on the surface.

According to the present invention there is provided an aqueous dispersion to be used in the manufacture of a hydrophobic coating, said aqueous dispersion comprises: inorganic particles, at least one fatty acid or a salt thereof, a polymeric binder, and water.

In one embodiment of the invention, the amounts of the components in the aqueous dispersion are
(a) from about 11 to about 95 wt % based on dry weight, preferably from about 30 to about 90 wt %, most preferably from about 40 to about 85 wt % of inorganic particles,
(b) from about 0.1 to about 5 wt % based on dry weight, preferably from about 0.3 to about 3 wt %, most preferably from about 0.5 to about 2.5 wt % of at least one fatty acid or a salt thereof, and
(c) from about 5 to about 80 wt % based on dry weight, preferably from about 10 to about 70 wt %, most preferably from about 15 to about 60 wt % of a polymeric binder,
with the proviso that the sum of the weight percentages of components (a), (b) and (c) is 100 weight percent, with the remainder of the dispersion being water and optional additives.

The inorganic particles according to the present invention have an apparent density from about 0.30 g/ml to about 4 g/ml, a BET specific surface area from about 1 to 20 m²/g, and a D₅₀ of less than about 20 μm.

In one embodiment of the present invention the inorganic particles have the following properties:
Apparent density from about 0.30 g/ml to about 2.7 g/ml, preferably from about 0.30 g/ml to about 0.80 g/ml and most preferably about 0.30 g/ml to about 0.65 g/ml.
BET specific surface area from about 1 to 20 m²/g, preferably more than about 3 m²/g and more preferably more than 5 m²/g.
D₅₀ less than about 20 μm, preferably from about 1 to about 10 μm, most preferably from about 2 to 5 μm.

In an alternative embodiment of the present invention the inorganic particles have the following properties:
Apparent density from about 1 g/ml to about 4 g/ml, preferably from about 2 to about 3.5 g/ml and most preferably about 2.5 g/ml to about 2.9 g/ml.
BET specific surface area from about 1 to 20 m²/g, preferably more than about 6 m²/g and more preferably more than 9 m²/g.
D₅₀ less than about 10 μm, preferably from about 0.1 to about 5 μm, most preferably from about 0.2 to 2 μm.

The inorganic particles used in the present invention may comprise a mixture of different inorganic particles with different properties. The inorganic particles used in the invention are preferably basic. Either the inorganic particles can be intrinsically basic or alternatively they may be treated to obtain basic functional groups on the surface. If it is desired to employ non-basic inorganic particles, then it is preferred to treat the non-basic inorganic particles so that they exhibit basic groups on the surface. Examples of such treatment include contacting said inorganic particles with an aqueous solution of at least one hydrolysable polyvalent metal salt, followed by neutralisation. The treatment is preferably carried out before the fatty acid or salt thereof is coated on the inorganic particles.

The inorganic particles used in the present invention in one embodiment comprise at least one substance selected from the group consisting of aluminium hydroxide, aragonite, barium sulphate, calcite, calcium sulphate, dolomite, magnesium hydroxide, magnesium carbonate, magnesite, ground calcium carbonate, precipitated calcium carbonate, titanium dioxide (e.g. rutile and/or anatase), satin white, zinc oxide, silica, alumina trihydrate, mica, talc, clay, calcined clay, diatomaceous earth, and vaterite or any combination thereof. If the particles are not intrinsically basic they need to be treated by any suitable method to make them basic. The inorganic particles are preferably calcium carbonate particles, more preferably precipitated calcium carbonate and most preferably aragonite.

Inorganic particles with relatively poor packing are preferred, which yields a suitable roughness of the coating. Inorganic particles with narrow particle size distribution are also preferred, possibly combined with a tendency to aggregate to larger secondaries. Preferably the inorganic particles are acicular or scalenohedral. The shape of the particles is however not limited to these two shapes. Also other thorny, spiky and needle like shapes are preferred for use according to the present invention. Other possible shapes include chestnut husk shapes.

Particles with a preferred shape have small size (a relatively low value of D₅₀), low density and high specific surface. Acicular aragonite is one preferred choice for the inorganic particles, especially acicular aragonite with a D₅₀ from about 0.1 to about 20 μm, preferably from about 0.2 to about 10 μm. In alternative embodiments, a combination of PCC (precipitated calcium carbonate) or GCC (ground calcium carbonate) products having different particle size distributions is used.

Preferably, inorganic particles without any appreciable residues of dispersants are used. Examples of such undesired dispersants include sodium polyacrylate polymers and copolymers.

A saturated or unsaturated fatty acid or salt thereof is employed. Advantageously, a fatty acid or salt thereof with linear or branched hydrocarbon chain is used. Preferably the fatty acid or salt thereof has 8 to 22, more preferably 10 to 18 carbon atoms. Particularly preferred fatty acids are selected from the group consisting of oleic acid, stearic acid and palmitic acid. Also preferred are salts of the latter fatty acids. The counter ions of a fatty acid salt can be any suitable ion. Examples include sodium ions and ammonium ions, which are available as common and inexpensive salts. Mixtures of fatty acids and/or their salts can be employed.

The inorganic particles are surface treated with a fatty acid or a salt thereof. Advantages of using one or more fatty acids are that fatty acids are inexpensive compared to silanes and fluorinated polymers and are readily available and used in many industries. Fatty acids interact in a suitable way with inorganic particles such as calcium carbonate and many fatty acids are approved for contact with food. The inorganic particles are coated by contacting them with an aqueous solution or dispersion comprising a fatty acid or a salt thereof. The aqueous solution or dispersion can be the same as the aqueous dispersion that comprises the binder. Alternatively the coating can be performed in a separate aqueous solution or dispersion. Preferably the coating of the inorganic particles is performed in a separate aqueous solution or dispersion. The inorganic particles can optionally be coated with several different fatty acids of salts thereof, optionally in several steps. The fatty acid or salt thereof forms a layer on the entire inorganic particle surface; alternatively the fatty acid or salt thereof forms a layer on a part of the surface. Optionally the coating comprises surfactants. The amount of fatty acid or salt thereof should be high enough so that the inorganic particles become dispersible in water. A suitable amount of fatty acid generally corresponds to a double layer of molecules on the surface of the inorganic particles. Thus the inorganic particles become dispersible in water or alternatively the ability to be dispersed in water is improved.

In one particularly preferred embodiment, inorganic particles comprising calcium carbonate are treated with stearic acid.

Examples of polymeric binders useful in the practice of the present invention include styrene-butadiene latex, styrene-acrylate latex, styrene-butadiene-acrylonitrile latex, acrylate latex, styrene-maleic anhydride latex, styrene-acrylate-maleic anhydride latex, polysaccharides, proteins, polyvinyl pyrrolidone, polyvinyl alcohol, polyvinyl acetate, cellulose and cellulose derivatives, epoxyacrylates, polyester, polyesteracrylates, polyurethanes, polyetheracrylates, oleoresins, nitrocellulose, polyamide, vinyl copolymers, various forms of polyacrylates, and copolymers of vinyl acetate, (meth)acrylic acid and vinyl versatate. Examples of polysaccharides include starch, carboxymethylated starch, agar and sodium alginate. Examples of proteins that can be suitably employed in the process of the present invention include albumin, soy protein, and casein. Mixtures of binders can be employed.

Examples of preferred binders include polyvinylalcohol, starch, proteins, cellulose derivatives and carboxylated latex. The preferred carboxylated latex is a synthetic latex stabilised predominantly by carboxylation. Preferably the glass transition temperature of the binder is in the range from about −40 to about 80° C., and more preferably from about 0 to about 50° C. Examples of the polymeric binder include the commercially available binders supplied by The Dow Chemical Company under the trade names UCAR Latex 123, UCAR Latex 169s, UCAR Latex 629, and NEOCAR ACRYLIC 820.

A synthetic latex, as is well known, is an aqueous dispersion of polymer particles prepared by emulsion polymerization of one or more monomers.

The monomer composition employed in the preparation of latex preferably comprises from about 10 to 95 pphm of a first monomer (A), from about 40 to 90 pphm of a second monomer (B), and from 0 to about 5 pphm of a functional monomer (C). As used herein, the term “pphm” means parts per hundred monomer, a term well known to those skilled in the art. Accordingly, the total parts monomer employed is 100 parts monomer, on a weight basis.

The first monomer (A) is a low Tg monomer, preferably comprising an alkyl acrylate or butadiene. The low Tg monomer is used in amounts of from about 10 pphm to about 95 pphm, preferably 15 pphm to 40 pphm. Examples of low Tg monomers include monomers having a Tg of less than 10° C. that are C₁-C₁₀ alkyl esters of acrylic acid, C₂-C₁₀ alkyl esters of alpha, beta-ethylenically unsaturated C₄-C₆ monocarboxylic acids, C₄-C₁₀ dialkyl esters of alpha, beta-ethylenically unsaturated C₄-C₈ dicarboxylic acids, and vinyl esters of carboxylic acids, including, without limitation, vinyl isobutyrate, vinyl-2-ethyl-hexanoate, vinyl propionate, vinyl isooctanoate and vinyl versatate and butadiene. The low Tg monomer can be selected from the group consisting of C₁-C₁₀ alkyl esters of (meth)acrylic acid, i.e. alkyl (meth)acrylates, and C₄-C₈ dialkyl esters of maleic, itaconic and fumaric acids. Preferably, at least one C₂-C₈ alkyl ester of acrylic acid is utilized. Particularly preferred low Tg monomers include ethyl acrylate, butyl acrylate, 2-ethyl hexyl acrylate, decyl acrylate, dibutyl maleate, dioctyl maleate, and butadiene with butadiene being most preferred. Mixtures of first monomers can be employed.

The second monomer (B) is a high Tg monomer having a Tg greater than 10° C. such as, for example, vinyl esters of carboxylic acids, the acid having from two to about 13 carbon atoms and styrene. Representative high Tg comonomers include methyl methacrylate, dimethyl maleate, t-butyl methacrylate, t-butyl isobornyl acrylate, phenyl methacrylate, acrylonitrile, vinyl esters of carboxylic acids having Tg of greater than 10° C., and styrene. Examples of such vinyl esters include vinyl pivalate, vinyl neodecanoate, vinyl neononanoate, and mixtures of branched vinyl esters such as the commercially available VeoVa 11 and EXXAR Neo-12. The second monomer advantageously is employed in an amount of from about 40 pphm to about 90 pphm, preferably 60 pphm to 85 pphm. Mixtures of high Tg comonomers can be employed.

It may also be desired to incorporate in the binder polymer minor amounts of one or more functional comonomers (C). Suitable copolymerizable comonomers (C) include, for example: acrylic acid; methacrylic acid; itaconic acid; fumaric acid; the half esters of maleic acid, such as monoethyl, monobutyl or monooctyl maleate; acrylamide; tertiary octylacrylamide; N-methylol (meth)acrylamide; N-vinylpyrrolidinone; diallyl adipate; triallyl cyanurate; butanediol diacrylate; allyl methacrylate; etc.; as well as C₂-C₃ hydroxyalkyl esters such as hydroxyethyl acrylate, hydroxy propyl acrylate and corresponding methacrylates. The comonomer (C) generally is used at levels of less than 5 pphm, preferably less than 2.5 pphm, depending upon the nature of the specific comonomer. Mixtures of comonomer (C) can be employed.

In addition, certain copolymerizable monomers that assist in the stability of the binder, e.g., vinyl sulfonic acid, sodium vinyl sulfonate, sodium styrene sulfonate, sodium allyl ether sulfate, sodium 2-acrylamide-2-methyl-propane sulfonate (AMPS), 2-sulfoethyl methacrylate, and 2-sulfopropyl methacrylate, can be employed as emulsion stabilizers.

These optional monomers, if employed, are added in very low amounts of from 0.1 pphm to about 2 pphm.

Methods for preparing synthetic latexes are well known in the art and any of these procedures can be used.

Suitable free radical polymerization initiators are the initiators known to promote emulsion polymerization and include water-soluble oxidizing agents, such as, organic peroxides (e.g., t-butyl hydroperoxide, cumene hydroperoxide, etc.), inorganic oxidizing agents (e.g., hydrogen peroxide, potassium persulfate, sodium persulfate, ammonium persulfate, etc.) and those initiators that are activated in the water phase by a water-soluble reducing agent. Such initiators are employed in an amount sufficient to cause polymerization. As a general rule, a sufficient amount is from about 0.1 to about 5 pphm. Alternatively, redox initiators may be employed, especially when polymerization is carried out at lower temperatures. For example, reducing agents may be used in addition to the persulfate and peroxide initiators mentioned above. Typical reducing agents include, but are not limited to, alkali metal salts of hydrosulfites, sulfoxylates, thiosulfates, sulfites, bisulfites, reducing sugars such as glucose, sorbose, ascorbic acid, erythorbic acid, and the like. In general, the reducing agents are used at levels from about 0.01 pphm to about 5 pphm.

The emulsifying agents are those generally used in emulsion polymerization. The emulsifiers can be anionic, cationic, surface-active compounds or mixtures thereof.

Suitable nonionic emulsifiers include polyoxyethylene condensates. Exemplary polyoxyethylene condensates that can be used include polyoxyethylene aliphatic ethers, such as polyoxyethylene lauryl ether and polyoxyethylene oleyl ether; polyoxyethylene alkaryl ethers, such as polyoxyethylene nonylphenol ether and polyoxyethylene octylphenol ether; polyoxyethylene esters of higher fatty acids, such as polyoxyethylene laurate and polyoxyethylene oleate, as well as condensates of ethylene oxide with resin acids and tall oil acids; polyoxyethylene amide and amine condensates such as N-polyoxyethylene lauramide, and N-lauryl-N-polyoxyethylene amine and the like; and polyoxyethylene thio-ethers such as polyoxyethylene n-dodecyl thio-ether.

Nonionic emulsifying agents that can be used also include a series of surface active agents available from BASF under the PLURONIC and TETRONIC trade names. In addition, a series of ethylene oxide adducts of acetylenic glycols, sold commercially by Air Products under the SURFYNOL trade name, are suitable as nonionic emulsifiers.

Representative anionic emulsifiers include the alkyl aryl sulfonates, alkali metal alkyl sulfates, the sulfonated alkyl esters, and fatty acid soaps. Specific examples include sodium dodecylbenzene sulfonate, sodium butylnaphthalene sulfonate, sodium lauryl sulfate, disodium dodecyl diphenyl ether disulfonate, N-octadecyl sulfosuccinate and dioctyl sodiumsulfosuccinate. The emulsifiers are employed in amounts effective to achieve adequate emulsification of the polymer in the aqueous phase and to provide desired particle size and particle size distribution.

Other ingredients known in the art to be useful for various specific purposes in emulsion polymerization, such as, acids, salts, chain transfer agents, chelating agents, buffering agents, neutralizing agents, defoamers and plasticizers also may be employed in the preparation of the latex. For example, if the polymerizable constituents include a monoethylenically unsaturated carboxylic acid monomer, polymerization under acidic conditions (pH 2 to 7, preferably 2 to 5) is preferred. In such instances the aqueous medium can include those known weak acids and their salts that are commonly used to provide a buffered system at the desired pH range.

Various protective colloids may also be used in place of or in addition to the emulsifiers described above in the preparation of the latex. Suitable colloids include casein, hydroxyethyl starch, carboxyxethyl cellulose, carboxymethyl cellulose, hydroxyethylcellulose, gum arabic, alginate, poly(vinyl alcohol), polyacrylates, polymethacrylates, styrene-maleic anhydride copolymers, polyvinylpyrrolidones, polyacrylamides, polyethers, and the like, as known in the art of emulsion polymerization technology. In general, when used, these colloids are used at levels of 0.05 to 10% by weight based on the total weight of the reactor contents.

The manner of combining the polymerization ingredients for the production of a synthetic latex can be by various known monomer feed methods, such as, continuous monomer addition, incremental monomer addition, or addition in a single charge of the entire amounts of monomers. The entire amount of the aqueous medium with polymerization additives can be present in the polymerization vessel before introduction of the monomers, or alternatively, the aqueous medium, or a portion of it, can be added continuously or incrementally during the course of the polymerization.

The final particle size of the latex advantageously can vary from 30 nm to 1500 nm.

The amount of binder must be high enough so that the coating exhibits the desired adhesion, mechanical strength and hydrophobicity, but on the other hand the amount of binder preferably is not so high that the hydrophobicity of the coating is reduced by the binder submerging the inorganic particles. A person skilled in the art can in the light of this description adjust the amount of binder within the range of the appended claims.

The degree of carboxylation for carboxylated latex should be adapted relative to the amount of fatty acid in the coating composition. It is undesired that the total number of carboxyl groups of the binder is higher than the total number of carboxyl groups of the fatty acid. Therefore, in general, low-carboxylated latex should perform best for low amounts of fatty acid.

The process for making the above-defined coating composition can be carried out in several ways according to the present invention. The process comprises the step of mixing an aqueous dispersion or solution of a polymeric binder and a mixture of fatty acid and inorganic particles. The process also comprises the step of coating the inorganic particles with a fatty acid. Said coating occurs in the mixture of fatty acid and inorganic particles.

Thus there is provided a method for preparing an aqueous dispersion comprising the step of mixing an aqueous dispersion of a polymeric binder with a mixture of inorganic particles and at least one fatty acid or a salt thereof.

In one embodiment the mixture of inorganic particles and at least one fatty acid or a salt thereof is prepared by
a) mixing said at least one fatty acid or a salt thereof with water,
b) mixing said inorganic particles with water, and then
c) mixing the mixtures from step a) and step b).

In an alternative embodiment said mixture of inorganic particles and at least one fatty acid or a salt thereof is prepared by
a) mixing at least one fatty acid or a salt thereof with water, and then
b) mixing the mixture from step a) with said inorganic particles.

In a preferred embodiment the polymeric binder is mixed with said inorganic particles at least 15 minutes after the mixing of said at least one fatty acid or a salt thereof with said inorganic particles.

Optionally, the aqueous dispersion according to the present invention comprises surfactants. If a surfactant is used in the aqueous dispersion it can be added before, at the same time as, or after the fatty acid or salt thereof. An optional surfactant can also be added before, at the same time as, or after the polymeric binder. The surfactant is preferably chosen so that it does not adversely affect the coating. Reactive surfactants, such as polymerizable surfactants, can be employed. Cationic surfactants are less preferred. Examples of surfactants include phosphoric acid alkyl ester and diphosphonate surfactants, silicone based surfactants, fluorosurfactants, and salts thereof. Mixtures of surfactants can be employed.

The aqueous dispersion optionally comprises other additives. Examples of such additives include antioxidants, biocides, coalescence agents, coloured inorganic particles, crosslinkers, defoaming agents, dyes, coalescence agents, fungicides, lubricants, optical brighteners, rheology modifiers, or any combination thereof. Preferably, such additives are compatible with the other components of the aqueous dispersion.

The present invention provides a method for coating a substrate with a hydrophobic, highly hydrophobic or superhydrophobic coating comprising: a) preparing an aqueous dispersion, b) contacting said substrate with said aqueous dispersion. Thereby the surface of a substrate is rendered hydrophobic, highly hydrophobic or superhydrophobic.

The aqueous dispersion as described above is contacted with the substrate to be coated. After contacting the substrate with the aqueous dispersion the substrate is dried. The amount of polymeric binder depends on several variables including the surface area of the inorganic particles. The larger the surface area, the more polymeric binder is required.

Preferably the coating according to the present invention is highly hydrophobic, i.e. it displays an equilibrium contact angle between 120 degrees and 150 degrees. More preferably the contact angle is higher than 135 degrees. Using the present invention it is even possible to manufacture superhydrophobic coatings, which display an equilibrium contact angle greater than 150 degrees.

Advantages of the present invention include, for example, that the coating can be applied in one step, that it is non-toxic, approved for food contact, cheap and that it can be produced in an environmentally friendly manner. A further advantage is that existing industrial coating processes can be used for applying the coating. Another advantage is that a hydrophobic surface is created without any need for stamping or etching.

### Architectural Coatings and Adhesive Release Surface Coatings

The composition described hereinabove comprising inorganic particles, at least one fatty acid or salt thereof, a polymeric binder and water can be employed in the preparation of architectural coatings and adhesive release surface coatings. In these applications, inorganic particles are employed in an amount sufficient to provide structure and body to the coating. Advantageously, a coating prepared from the composition described hereinabove contains the inorganic particles in an amount of from about 11 to about 95 weight percent, based on the dry weight of the coating composition, preferably from about 30 to about 90 weight percent, and preferably from about 40 to about 85 weight percent. Inorganic fillers that are commonly employed in the preparation of coatings are advantageously employed. Preferred inorganic fillers for such coating compositions include clay, titanium dioxide, aluminum hydroxide, magnesium hydroxide, zinc oxide, feldspar, silica, magadiite, ground calcium carbonate and precipitated calcium carbonate.

For the preparation of such coating compositions, the amount of fatty acid or salt thereof employed is an amount sufficient to make the inorganic pigment hydrophobic. Advantageously, the amount of fatty acid or salt thereof employed in coating preparation is from about 0.1 to about 5 weight parts based on the total weight of inorganic pigment in the coating composition, preferably is from about 0.3 to about 3 weight parts, and most preferably is from about 0.5 to about 2.5 weight parts.

In the preparation of such coating compositions, the amount of polymeric binder employed advantageously is an amount that is sufficient to bind the inorganic particles together, increase the strength of the coating, and provide adhesion to the intended substrate. The amount of polymeric binder employed in the coating composition advantageously is from about 5 to about 80 weight percent based on the dry weight of the coating composition, preferably is from about 10 to 70 weight percent, and more preferably is from about 15 to about 60 weight percent.

The coating composition can be prepared according to methods known to those skilled in the art. The coating composition can include adjuvants known in the art such as, for example, dispersants, wetting agents, thickeners, biocides, and other known adjuvants in their customary amounts.

Substrates to which the architectural coating composition may be applied include, for example, wood, plastic, block, asphalt, metal and previously primed substrates. Preferred substrates are indoor and outdoor substrates such as walls, ceilings, highways, decks, floors and the like. The coating composition of this invention may be applied to a substrate by methods well known in the art of applying coatings such as air-assisted spray, airless spray, brush, roller, squeegee and the like.

The adhesive release surface coating composition may be applied to any surface for which quick release of adhesive materials, such as tape, is desired.

It is to be understood that this invention is not limited to the particular embodiments shown here. The following examples are provided for illustrative purposes and are not intended to limit the scope of the invention since the scope of the present invention is limited only by the appended claims and equivalents thereof. All parts and percentages are by weight unless otherwise indicated.

### SPECIFIC EMBODIMENTS OF THE INVENTION

If not otherwise indicated, the following methods apply to all examples mentioned below.

### Dry Stain Size Measurement

In the stain test 5 drops of an exact amount (9 μl, i.e. drop diameter 2.58 mm) of a blue dye aqueous solution are auto-pipetted (from a fixed height of 1.9 mm from drop bottom to coat surface) on the coated surface. The blue dye is added to aid visual inspection of stain size after complete evaporation of the water. The surface tension of the colored water is the same as the non-colored deionized water. The samples are stored at 23° C. and 50% relative humidity, and the final size of the dry stain after complete evaporation is measured with a sliding gauge, both in machine direction MD and cross direction CD. The values given below correspond to the mean of the set of 5 drops measured in these two directions. They are expressed in a dimensionless form by dividing the stain diameter by the drop diameter prior to contact (i.e. 2.58 mm). This measure relates to the total ability of the substrate to resist both surface spreading and sub-surface penetration and spreading (within the top coating layer and layers below) over long times. A hydrophobic surface leads to a smaller stain diameter than the initial droplet diameter. This method can be used to rank the samples' performance regarding hydrophobicity.

### Contact Angle Measurement

Short-time contact angles of drops of deionized water (i.e. without the blue dye) on the coated sheets are measured with a Fibro-DAT 1100 contact angle instrument, using the dropping procedure (i.e. 5 drops at different places) as in the staining experiments described above. The time from contact to measurement of advancing angle is approximately 1-2 s. This is a standard measure of short-term hydrophobicity, reflecting the ability of the substrate to reject water drops on first contact.

### Rolling Angle Measurement

The drop rolling tests are performed using a tilt table. The same blue dye solution as mentioned above is autopipetted in a similar manner as in the stain test on the coated samples pre-inclined at 5 fixed angles (2.5, 5, 10, 15 and 20° from horizontal). The lowest angle for which free rolling occurs, i.e. the drop rolls the entire distance of the sample size (around 10 cm), is the value assigned to the substrate. Failure to roll freely at 20° is regarded as a no-score, despite the fact that free rolling may occur at higher angles not tested (e.g. approaching vertical). It is expected that drop rolling is closely dependent on advancing initial contact angle (see above).

### Example 1

### Release Coating for Adhesives

A. Coating formulation

### PCC/Oleate Suspension

Precipitated calcium carbonate (PCC) (STURCAL F, Specialty Minerals Inc.) (Particle size D₅₀ ca. 2.5 μm, apparent density 0.32-0.43 g/ml, and BET surface area ca. 6 m²/g) particles is mixed together with water and a sodium oleate solution with a mixer. The total content of calcium carbonate in water is about 50 wt % and the content of sodium oleate is 2 wt % per pigment weight (dry on dry). This suspension is mixed until it is essentially homogenous.

### Latex-Based Release Coating

To prepare a latex-based release coating, 30 wt % per pigment weight (dry on dry) of NEOCAR ACRYLIC 820 latex (available from The Dow Chemical Company) is added to the above-mentioned aqueous suspension containing sodium oleate and PCC, and the resulting mixture is mixed with a magnetic stirrer to obtain an essentially homogenous mixture. The total solids content of the formulation is 39 wt % and pH is 9.4. Coatings are prepared on a release base paper using an RK Instruments lab coater using Rod 3. The coatings are dried in an oven with air flow for 2 minutes at 110° C. The coat weight is approximately 15 g/m².

B. A Reference Coating (Comparative Experiment 1 B) is made by Following the same Procedure as above, but without Sodium Oleate Addition.

The coatings are tested for their contact angle and rolling angle to evaluate their hydrophobicity. Further, for each coating a Cobb test is performed according to Tappi standard T-441 om-90, and a Peel force test is conducted. The peel force (180°) is measured after 20 minutes using an Instron peel force instrument.

TABLE 1
Release coating test results

| | Contact angle | Rolling Angle |
|---|---|---|
| Ex. 1A | 139.7° (±3.9°) | 5° |
| C. E. 1B* | 119.0° (±2.6°) | no rolling |

Test results for tape release application:

| | Peeling load (180°) | Cobb |
|---|---|---|
| Ex. 1A | 4.3 N (±0.4 N) | 9.8 g/m2 |
| C. E. 1B* | 6.8 N (±0.4 N) | 18.9 g/m2 |

*Not an embodiment of the invention.

### Example 2

### Process for Making Coatings, Caulks and Adhesive Release Surfaces with Water Soluble Binders

Coating compositions are formulated using a PCC/oleate suspension as prepared in Example 1. The water soluble binders used are polyvinyl alcohol (PVOH, Kuraray, MOWIOL 4-98), soy protein (Dupont Soy Polymers, Pro-Cote PC 200) and starch (Cerestar, C-FILM 7311). Binder solutions are prepared by mixing the water soluble binders with water while heating the mixture. Solids contents of the solutions are indicated below.

PVOH is added at 13.1% solids content into the sodium oleate treated STURCAL F (50% solids). Two coating formulation are prepared by using two different addition levels of PVOH, namely 10 wt % 15 wt % per pigment weight. The solids content of the formulations are about 38.5% and the pH for both systems is 10.2.

Soy protein is added at 12.7% solids content into the sodium oleate treated STURCAL F (50% solids). One coating formulation is prepared by adding soy protein 15 wt % per pigment weight into the system. The final solids content of the formulation is 37.2% and pH is 9.6.

Starch is added at 12.1% solids content into the sodium oleate treated STURCAL F (50% solids). One coating formulation is prepared by adding 30 wt % per pigment weight starch into the system. The final solids content of the formulation is 31.3% and the pH is 9.9.

The coatings are done on base paper with Sheen lab coater (Automatic film applicator, 1131, Sheen Instruments Ltd). The coatings are dried in oven for 6 minutes at 100° C.

Contact angle is measured with Fibro Dat 1100 instrument and the average of five measurements at time 0.98 s is given in the table below.

TABLE 2
Test results for water soluble binders

| | Contact angle | Stain size | Rolling Angle |
|---|---|---|---|
| 10 pph PVOH | 139.7° (±5.7°) | 0.9 (±0.4) | 10° |
| 15 pph PVOH | 141.8° (±5.4°) | 1.1 (±0.5) | 10° |
| 15 pph Soy protein | 117.6° (±35°) | 3.3 (±0.3) | 10° |
| 30 pph Starch | 100.1° (±8.3°) | 20.2 (±34.8) | — |

pph (parts per hundred pigment or grams per hundred grams of pigment)

### Example 3

### Coatings, Caulks and Sealants

### Procedure to Make Latex Blends

50 grams (wet) of latex is mixed with 100 g of pigment slurry containing 50 g pigment (STURCAL F or DURAMITE) and 50 g water for 10 minutes. DURAMITE is an 11 micron ground calcium carbonate (GCC) available from ECC.

When employed, the oleic acid is added at 2% on pigment solids and neutralized to pH 8.

In some cases QP-3L (cellulosic thickener) is added to the mixture to simulate the effect of additives. This is added at 1% based on polymer solids. Binders are identified in Table 3. Additional coating formulation details are listed in Table 4.

### Measurement of Dirt Pickup Resistance:

For the purposes of the invention, the term “Dirt Pick-Up Resistance Value” is determined using the following procedure. The relevant coating mixture is applied to a Leneta chart using a 30 mil drawdown bar, except that the UCAR 123 and UCAR169s latex-containing mixtures are cast using a spatula to create a 3/16th inch thick film, and is allowed to dry overnight.

The reflectance of the coatings is measured. The CIE (International Commission on Illumination) system of color is used to indicate dirt using X, Y, and Z values.

A 2% aqueous solution of coal ash is made to mimic dirty rain. The solution is applied to the coating. The coated charts are allowed to dry overnight. The next day the coated charts are washed with distilled water. The reflectances of the coatings are again measured. The % drop in reflectance is calculated using the following equation:

(Rd−Rc)/Rc*100=% drop

Rc=initial reflectance of the film
Rd=reflectance of the dirty film after water wash

The % drop in values for X, Y, and Z indicates the “dirtiness of the film” with larger negative numbers indicating dirtier films. The average % drop for X, Y, and Z is the Dirt Pick-Up Resistance Value.

The test results are listed in Tables 4 and 5.

### Dirt Pick-Up Resistance Improvement

The Dirt Pick-Up Resistance Improvement is determined by comparing the Dirt Pick-Up Resistance Value of a coating of the invention (DPRV)ₐ to the Dirt Pick-Up Resistance Value for a second coating made from a composition that is identical to the composition of the first coating except that the second coating composition is free of the fatty acid component (DPRV)_{b}. The Dirt Pick-Up Resistance Improvement is calculated as follows:

Dirt Pick-Up Resistance Improvement=(DPRV)ₐ−(DPRV)_{b}

For example, if (DPRV)ₐ is −30% and (DPRV)_{b} is −40%, then (DPRV)ₐ−(DPRV)_{b} will be calculated as −30%−(−40%)=−30%+40%=10% Dirt Pick-Up Resistance Improvement. In one embodiment of the invention, the Dirt Pick-Up Resistance Improvement of a coating prepared via the process of the invention advantageously is at least about 2%, preferably is at least about 3%, more preferably is at least about 5%, and most preferably at least about 10%.

### Measurement of Contact Angle

In this example a goniometer (Rame-Hart, Inc. model number 100-00-115) is used to measure water contact angles. Three contact angle measurements are taken using a film of each sample as the substrate. For each sample, contact angle is measured on either side of the water bead and a third measurement is taken on the side that the original measurement is made. All measurements are taken within 2 minutes of adding the bead of water. These measurements are averaged and the results are shown in Tables 4 and 5. It is clear that the addition of oleic acid to the mixture imparts significantly increased hydrophobicity.

TABLE 3
Latex description for typical latexes for coatings, caulks and sealants

| | | | Minimum | | |
|---|---|---|---|---|---|
| | | | Film | | |
| | | | Forming | | |
| | | Particle | Temperature | | |
| Product Name | Solids | size (nm) | (° C.) | Tg (° C.) | Typical use |
| NeoCAR Acrylic | 45 | 70 | 17 | 20 | Blush resistant |
| 820 | | | | | coatings |
| UCAR Latex 629 | 55 | 200 | 9 | 5 | Low VOC |
| | | | | | Architectural |
| | | | | | coatings |
| UCAR Latex 169s | 62.5 | 300 | <0 | −22 | Caulks and |
| | | | | | Sealants, |
| | | | | | Elastomerics, |
| | | | | | EIFS |
| UCAR Latex 123 | 60 | 500 | <0 | −17 | Caulks and |
| | | | | | Sealants, |
| | | | | | Elastomerics, |
| | | | | | EIFS |

In Table 3 the particle size is weight average particle size.

TABLE 4
Dirt pick-up resistance and contact angle results
for coatings including formulation details.

| | | Oleate | | | | | Contact |
|---|---|---|---|---|---|---|---|
| | | added | % | % | % | Average % | Angle |
| Latex | Pigment | (Yes/No) | drop X | drop Y | drop Z | drop (%) | (°) |
| 820* | none | No | | | | | 92 |
| 820 | GCC | Yes | −10 | −9 | −11 | −10 | |
| 820* | GCC | No | −39 | −41 | −43 | −41 | 84 |
| 820 | PCC | Yes | −1 | −1 | −2 | −1 | 142 |
| 820* | PCC | No | −5 | −6 | −7 | −6 | 88 |
| 820 w | PCC | Yes | −7 | −7 | −8 | −7 | |
| QP3L | | | | | | | |
| 820 w | PCC | No | −33 | −33 | −35 | −34 | |
| QP3L* | | | | | | | |
| 629* | none | No | | | | | 33 |
| 629 | PCC | Yes | −34 | −33 | −37 | −35 | 70 |
| 629* | PCC | No | −44 | −45 | −48 | −46 | |

*Not an embodiment of the invention.

TABLE 5
Dirt pick-up resistance and contact angle results
for caulks and sealants including formulation details.

| | | Oleate | | | % | Average | Contact |
|---|---|---|---|---|---|---|---|
| | | added | % | % | drop | % drop | Angle |
| Latex | Pigment | (Yes/No) | drop X | drop Y | Z | (%) | (°) |
| 169s* | none | No | | | | | 75 |
| 169s | PCC | Yes | −46 | −45 | −49 | −46 | 90 |
| 169s* | PCC | No | −63 | −63 | −66 | −64 | |
| 123* | none | No | | | | | 91 |
| 123 | PCC | Yes | −41 | −42 | −44 | −42 | 108 |
| 123* | PCC | No | −48 | −48 | −46 | −48 | |

*Not an embodiment of the invention.

1. A process comprising preparing an architectural coating composition that provides a hydrophobic coating when applied to a substrate, the composition being in the form of an aqueous dispersion, the composition comprising:
a) inorganic particles
b) at least one fatty acid or a salt thereof,
c) a polymeric binder, and
d) water.

2. The process of claim 1, wherein said aqueous dispersion comprises:
a) from about 11 to about 95 wt % based on dry weight (excluding water) of inorganic particles,
b) from about 0.1 to about 5 wt % based on dry weight (excluding water) of at least one fatty acid or a salt thereof
c) from about 5 to about 80 wt % based on dry weight (excluding water) of a polymeric binder, and
d) the rest being water and optional additives,
with the proviso that the sum of the weight percentages of components (a), (b) and (c) is 100 weight percent.

3. The process of claim 2, wherein said inorganic particles comprise at least one substance selected from the group consisting of aluminium hydroxide, aragonite, barium sulphate, calcite, calcium sulphate, dolomite, magnesium hydroxide, magnesium carbonate, magnesite, ground calcium carbonate, precipitated calcium carbonate, titanium dioxide, satin white, zinc oxide, silica, alumina trihydrate, mica, talc, clay, calcined clay, diatomaceous earth and vaterite or any combination thereof.

4. The process of claim 2, wherein said fatty acid or salt thereof has 8 to 22 carbon atoms.

5. The process of claim 2, wherein said fatty acid or salt thereof has 10 to 18 carbon atoms.

6. The process of claim 2, wherein said fatty acid is selected from the group consisting of oleic acid, stearic acid, palmitic acid, and mixtures thereof.

7. The process of any claim 2, wherein said fatty acid salt is a salt of a fatty acid selected from the group consisting of oleic acid, stearic acid, palmitic acid, and mixtures thereof.

8. The process of claim 2, wherein said polymeric binder is selected from the group consisting of a synthetic latex, proteins, cellulose derivative, polyvinyl alcohol, polysaccharides, proteins, polyvinyl pyrrolidone, polyvinyl alcohol, polyvinyl acetate, cellulose and cellulose derivatives, epoxyacrylates, polyester, polyesteracrylates, polyurethanes, polyetheracrylates, oleoresins, nitrocellulose, polyamide, vinyl copolymers and polyacrylates.

9. The process of claim 2, wherein said inorganic particles are contacted with at least one hydrolysable polyvalent metal salt, followed by neutralisation.

10. The process of claim 2, wherein said binder comprises at least one substance selected from the group consisting of styrene-butadiene latex, styrene-acrylate latex, styrene-butadiene-acrylonitrile latex, acrylate latex, styrene-maleic anhydride latex, styrene-acrylate-maleic anhydride latex, polysaccharides, starch, proteins, polyvinyl pyrrolidone, polyvinyl alcohol, polyvinyl acetate, cellulose and cellulose derivatives, epoxyacrylates, polyester, polyesteracrylates, polyurethanes, polyetheracrylates, oleoresins, nitrocellulose, polyamide, vinyl copolymers and polyacrylates.

11. The process of claim 1 wherein a coating prepared from the architectural coating composition exhibits a Dirt Pick-Up Resistance Improvement of at least about 2%.

12. A process comprising coating an architectural surface with a coating composition prepared by the process of claim 1.

13. A process comprising preparing an adhesive release surface coating composition that provides a hydrophobic adhesive release surface coating when applied to a substrate, the composition being in the form of an aqueous dispersion, the composition comprising:
a) inorganic particles
b) at least one fatty acid or a salt thereof,
c) a polymeric binder, and
d) water.

14. The process of claim 13, wherein said aqueous dispersion comprises:
a) from about 11 to about 95 wt % based on dry weight (excluding water) of inorganic particles,
b) from about 0.1 to about 5 wt % based on dry weight (excluding water) of at least one fatty acid or a salt thereof
c) from about 5 to about 80 wt % based on dry weight (excluding water) of a polymeric binder, and
d) the rest being water and optional additives,
with the proviso that the sum of the weight percentages of components (a), (b) and (c) is 100 weight percent.

15. The process of claim 14, wherein said fatty acid or salt thereof has 8 to 22 carbon atoms.

16. The process of claim 15, wherein said fatty acid or salt thereof has 10 to 18 carbon atoms.

17. The process of claim 16, wherein said fatty acid is selected from the group consisting of oleic acid, stearic acid, palmitic acid, and mixtures thereof.

18. A process for improving the hydrophobicity of coatings prepared from an architectural coating composition or adhesive release surface coating composition, the process comprising preparing the composition such that it is in the form of an aqueous dispersion and comprises:
a) inorganic particles
b) at least one fatty acid or a salt thereof,
c) a polymeric binder, and
d) water.

19. The process of claim 18, wherein said aqueous dispersion comprises:
a) from about 11 to about 95 wt % based on dry weight (excluding water) of inorganic particles,
b) from about 0.1 to about 5 wt % based on dry weight (excluding water) of at least one fatty acid or a salt thereof
c) from about 5 to about 80 wt % based on dry weight (excluding water) of a polymeric binder, and
d) the rest being water and optional additives,
with the proviso that the sum of the weight percentages of components (a), (b) and (c) is 100 weight percent.

20. The process of claim 19, wherein said fatty acid or salt thereof has 8 to 22 carbon atoms.
